(19) United States
(12) Patent Application Publication
(10) Pub. No.: US 2008/0297301 A1
(43) Pub. Date: Dec. 4, 2008

(54) HIGH VOLTAGE FUSE

(75) Inventors: Daniel B. Onken, Chathman, IL (US); Michael Duff, Suzhou (CN); William R. Travis, Park Ridge, IL (US); Stephen J. Whitney, Lake Zurich, IL (US)

Correspondence Address: BELL, BOYD & LLOYD LLP, P.O. BOX 1135, CHICAGO, IL, 60690, US

(73) Assignee: Littelfuse, Inc., Des Plaines, IL (US)

(21) Appl. No.: 12/132,771

(22) Filed: Jun. 4, 2008

Related U.S. Application Data
(60) Provisional application No. 60/941,878, filed on Jun. 4, 2007.

(51) Int. Cl. H01H 71/20

(52) U.S. Cl. 337/219

(57) ABSTRACT

A high voltage fuse is disclosed. The high voltage fuse is compact and includes a molded plastic housing that holds connecting terminals, a fuse element, and optionally, a spring between one of the terminals and the fuse element or thin wire. When the fuse opens upon melting of the fuse element, the spring pulls apart ends of the wire and separates them as far as the spring and housing allow. The terminals may be mounted in separated parts of the housing, separated in some embodiments by the spring acting as an arc barrier. When the fuse element melts and the ends are pulled apart, the separation itself, or the arc barrier, prevents arcing between ends of the fuse element. In another embodiment, the housing itself furnishes a non-conducting plastic spring which urges the fuse link apart, the spring itself dividing the housing into two separate parts to prevent arcing.

### BACKGROUND

This invention relates generally to high voltage fuses, and more particularly for fuses with fuse elements that melt and are then pulled apart by a spring when exposed to a current exceeding the rated current. The spring may be in series with the fuse element or fuse link, typically a thin piece of wire. Spring fuses protect electrical circuits from abnormal current overloads and short circuits. The fuse link melts or opens due to self-heating in a predetermined length of time, interrupting the abnormal flow of current, thereby protecting the associated circuitry and equipment from fire.

Many of these spring-type fuses are extensively used in appliances, such as microwaves, and are therefore designed to be rated for service between 2000 volts and 7000 volts. When the fusible link opens in high voltage fuses, an arc forms between the ends of the fusible link and is only extinguished when the element melts back to a distance where the open circuit voltage is not sufficient to sustain the arcing. At lower voltages, the arc will not cause serious damage to the metal and plastic portions of the fuse and the fuse housing. At higher voltages, however, extensive damage to the metal and plastic portions of the fuse and its surroundings can occur.

Therefore, there is a need to prevent arcing and damage to the other portions of the fuse. One way to achieve this is to increase the rate at which the ends of the melting fuse separate. There is also a need in high voltage circuits to assure that there is adequate separation after the fuse operates to prevent restriking of the arc and excessive leakage current. Older fuses may include a spring in series with the fusible link, such as U.S. Pat. No. 341,289. This fuse described in this patent provides a quick separation, but when it interrupts high voltage electricity, the ends of the springs and the fuse element may still move and contact surrounding objects. Improvements, such as U.S. Pat. No. 3,246,105, have used a spring attached in a non-conductive way, to pull apart the fusible link when the fuse operates. Such schemes, as seen in FIG. 5, can become very complex and expensive to manufacture.

Other complicated schemes, which may still be subject to arcing, are also disclosed in WO 82/03724. This patent document discloses a fuse element in series with a spring to keep the fuse element in tension, and surrounded by a resistor. On a low level overload current, the resistor self-heats, melting the solder connecting the spring and the fuse element, allowing the two to separate. It is clear that assembly of the fuse within the wound resistor will be labor-intensive. What is needed is a better way of providing a fuse element that will be quick and easy to manufacture, will activate quickly to provide over-current or over-voltage protection, and is not likely to arc excessively during activation.

### SUMMARY

Embodiments of the present invention provide such a fuse. One embodiment is a fuse. The fuse includes a housing having a first part and a second part, a first terminal mounted near the first part and a second terminal mounted near the second part, a fuse element mounted in the first part of the housing and connected to the first terminal, a conductive spring mounted in the second part of the housing, the spring connected to the second terminal and connected to the fuse near the first part, wherein the fuse element and spring are configured to place the fuse element in a state of flexure, and are configured so that when the fuse element opens, the spring pulls away from the first part, and a cover configured for covering the first part and the second part.

Another embodiment is a fuse. The fuse includes a housing having a first part and a second part separate from the first part, a first terminal mounted near the first part and a second terminal mounted near the second part, a fuse element mounted in the first part of the housing and connected to the first terminal, a conductive spring mounted in the second part of the housing, the spring connected to the second terminal and connected to the fuse near the first part, wherein the fuse element and spring are configured to place the fuse element in a state of flexure, and are also configured so that when the fuse element opens, the spring pulls away from the first part, and a cover configured for covering the first part and the second part.

Another embodiment is a fuse. The fuse includes a housing, a first terminal and a second terminal mounted to the housing, a fuse element mounted in the housing and connected to the first terminal and the second terminal, a non-conductive spring mounted in the housing, between the first and second terminals, wherein the spring is configured to place the fuse element in a state of flexure, and is also configured so that the spring urges apart the fuse element upon melting of the fuse element, and a cover configured for covering the first part and the second part.

Another embodiment is a fuse. The fuse includes a housing, a spring and a fuse element in series with the spring, and a first terminal and a second terminal connected with the spring and the fuse element, the first and second terminals mounted in the housing. The fuse also includes a cover with a stop, the cover and the housing configured so that when the cover is assembled to the housing, the fuse element passes through a pathway in the stop, and wherein the spring and the fuse element are held in tension by the stop and at least one of the first and second terminals.

Another embodiment is a fuse. The fuse includes a housing, a closure for the housing, two terminals assembled into the closure, two arc barriers within the housing, the arc barriers configured to resist arcing upon activation of the fuse, and a fuse element connected between the terminals and traversing a serpentine path between the terminals.

Another embodiment is a method of protecting an electrical device with a fuse. The method includes a step of connecting the electrical device to a source of electrical power in series with a fuse, wherein the fuse includes a housing having a first part and a second part, a first terminal mounted near the first part and a second terminal mounted near the second part, a fuse element connected to the first terminal and the second terminal, and a spring mounted in the housing, wherein the fuse element and the spring are configured so that the spring places the fuse element in flexure. The method also includes steps of opening the fuse by separating the fuse element with the spring when the fuse element melts and separating ends of the fuse element a particular minimum distance.

Additional features and advantages are described herein, and will be apparent from, the following Detailed Description and the figures.

### BRIEF DESCRIPTION OF THE FIGURES

FIG. 1 is a perspective view of a first embodiment of a high voltage fuse incorporating the advantages thereof;

FIG. 2 depicts a second embodiment of a high voltage fuse;

FIG. 3 depicts a third embodiment of a high voltage fuse;

FIGS. 4a and 4b depict a fourth embodiment of a high voltage fuse;

FIG. 5 depicts a fifth embodiment of a high voltage fuse;

FIG. 6 depicts another embodiment of a high voltage fuse;

FIGS. 7a-b depict another embodiment of a high voltage fuse;

FIGS. 8a-b depict another embodiment of a high voltage fuse;

FIGS. 9a-b depict alternate housings for the embodiments of FIGS. 7a-7b and 8a-8b; and

FIGS. 10a-10c depict additional embodiments of a high voltage fuse.

### DETAILED DESCRIPTION

There are many embodiments of the high voltage fuse disclosed herein. The advantage is a quick clearing of the fuse, caused by a spring, preferably a leaf spring that urges apart the ends of the fuse element. The ends of the fuse element are actively moved apart during the fuse opening process, rather than relying on a slower melt-back and the associated prolonged arcing. This helps to minimize the chances of excessive arcing and damage to the electrical equipment which the fuse is intended to protect. The fuses disclosed herein are intended for use with electrical power at AC voltages from about 125 volts to about 7000 volts r.m.s. and for DC power at voltages from about 125 volts to about 7000 volts. Current ratings can range from about 200 milli-amperes to about 20 amperes.

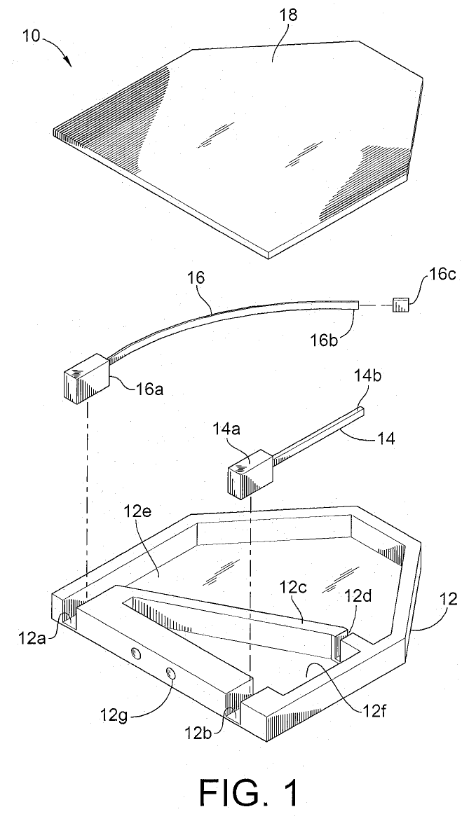

A first embodiment is disclosed in FIG. 1. High voltage fuse 10 includes a housing 12 and a cover 18, both preferably molded from insulative plastic materials, such as polyethylene, polypropylene, acrylic, or any other non-conductive thermoplastic or thermoset material suitable for insulative electrical applications. Housing 12 is in the general shape of a polygon, in this case an irregular hexagon. As is typical of industrial practice, such shapes will not strictly be a polygon because the corners are rounded for ease of manufacture, avoidance of stress concentrators, and safety for assembly and installation personnel.

The housing includes a bottom side with two openings 12a, 12b for terminals for connection to a source of electrical power and for an appliance or other device that uses electricity. Other embodiments may have openings on more than one side. Opening 12a opens onto housing first part 12e while opening 12b opens into housing second part 12f. The housing also includes an internal wall 12c with an opening 12d. Internal wall 12c may serve as an arc barrier when the fuse opens.

Fuse 10 also includes a first conductor 14 including a first terminal 14a and a fuse element 14b, a thin wire. Fuse 10 also includes a second conductor 16, including a second terminal 16a and a conductive leaf spring 16b. A connector 16c is used to connect the conductive leaf spring 16b to the fuse element 14b, thus providing electrical continuity between terminals 14a, 16a. When the fuse is assembled, the first and second conductors are installed so that the first and second terminals extend from openings 12a, 12b while the fuse element 14b and leaf spring 16b are connected with connector 16c near wall opening 12d. The leaf spring has been bent and is in a state of flexure or bending. Its resilience or resistance to this configuration puts fuse element 14b into a state of flexure, in which part of the force of the spring acting upon the fuse element is directed along a longitudinal axis of the fuse element while another part of the force is directed perpendicular to the longitudinal axis. In contrast, previous fuses have used a coil spring in tension, i.e., directly opposed, with the fuse element.

If the current in the electrical path increases sufficiently, fuse element 14b will self-heat and eventually melt. Leaf spring 16b helps to insure that the circuit is opened by urging apart connector 16c and that portion of the fuse element connected intimately to connector 16c. The spring helps to insure a quick separation of the element, while wall 12c acts as an arc barrier to reduce the arcing that may occur while the fuse is in the process of interrupting the current. The spring will separate from the fuse element opening 12d a maximum distance from opening 12d to a point near the back wall of housing 12. In some embodiments, it is necessary to have a minimum separation distance between ends of the melted fuse. One example is a minimum of 17.5 mm. The 17.5 mm distance is a requirement set by a safety agency in Germany, TÜV (short for Technischer Überwachungs-Verein, or Technical Monitoring Association in English). Other embodiments may use other known, minimum separation distances.

This distance helps to insure that no arcing occurs and that no inadvertent reconnection is made. The actual minimum distance between the melted ends is determined by testing and a result obtained, with attention to statistical deviations. Even with appropriate design of the fuse element, it is difficult to assure the amount of fuse element melt-back. Thus, there will be some variation in the lengths of the ends of the melted fuse, and there will be some variation in the separation achieved upon melting. In testing of the embodiment of FIG. 1, and with housing dimensions of about 51×48 mm (about 2 inches×2 inches), 10.8 mm thick (about ½ inch), a minimum separation of 20 mm was achieved.

The housing, as mentioned, is preferably a molded plastic part, with the internal walls and with the openings in the internal and external walls. The housing is preferably insert molded around at least one of the first or second conductors 14, 16. The conductor or conductors are placed in the injection molding tool or other tool, and the housing is molded, intimately connecting the conductor to the housing. The end of the fuse element 14b should extend sufficiently beyond wall 12c so that an assembly worker can make the connection; alternatively, the first and second conductors may be assembled together before molding and this assembly is then insert molded.

After molding, the housing and the internal parts may be inspected. The cover may then be added. The cover may be attached by male snap fits on the underside of the cover that mate with female snap fits or orifices molded into the inside of housing 12, for example one or two snap fits in each of the first and second parts of the housing. Tabs and slots or any other suitable attachments may be used. In addition, housing 12 may also include openings, such as orifices 12g, for attaching fuse 10 to an outside structure, such as an appliance or other housing for the device that the fuse is intended to protect.

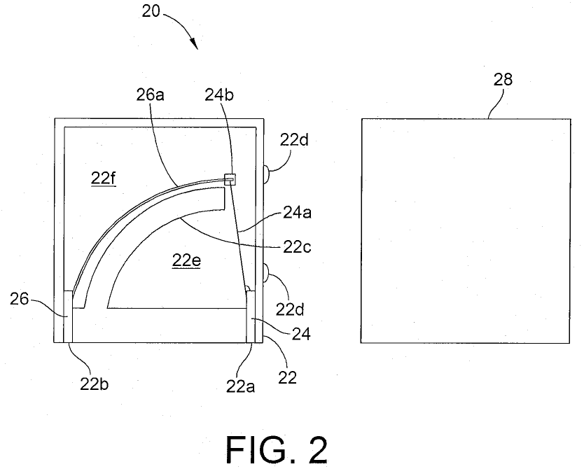

A second embodiment is depicted in FIG. 2. High voltage fuse 20 includes a housing 22 and a cover 28. In this embodiment, housing 22 is molded with four sides, and is generally rectangular, although production parts are expected to have rounded corners and thus the housing will not strictly be a polygon, but will instead have the general shape of a polygon, in this case a rectangle. The housing includes two openings, 22a, 22b for terminals 24, 26 and an internal curved wall 22c, an arc barrier. The inside of the housing is generally divided by arc barrier 22c into a first portion 22e for mounting a fuse element and a second portion 22f for mounting a spring. Terminal 24 is connected to fuse element 24a while terminal 26 is connected to conductive leaf spring 26a. The leaf spring is connected to the fuse element by a connector 24b. Housing 22 also includes mounting tabs 22d on one side of the housing.

In this embodiment, when the fuse is activated, the fuse element will self-heat and eventually will be pulled into two halves by leaf spring 26a. Arc barrier 22c will help to prevent arcing between the remnants of fuse element 24a. Leaf spring 26a may be crimp-connected to terminal 26, or may be soldered, brazed, or even welded. Fuse element 24a may be crimp-connected to terminal 24, and is preferably not brazed or solder-connected. Connector 24b is preferably a crimp connector, although any suitable mechanical connector may be used. In this embodiment, when the fuse element melts, leaf spring 26 a will flex until it reaches the top inside of the housing, or close to the top side, while the fuse element will tend to go in the opposite direction. Thus, a significant separation will be achieved between the ends of the fuse element. In one embodiment, this distance will be a minimum of 17.5 mm. In other embodiments, other distances may be designed and achieved.

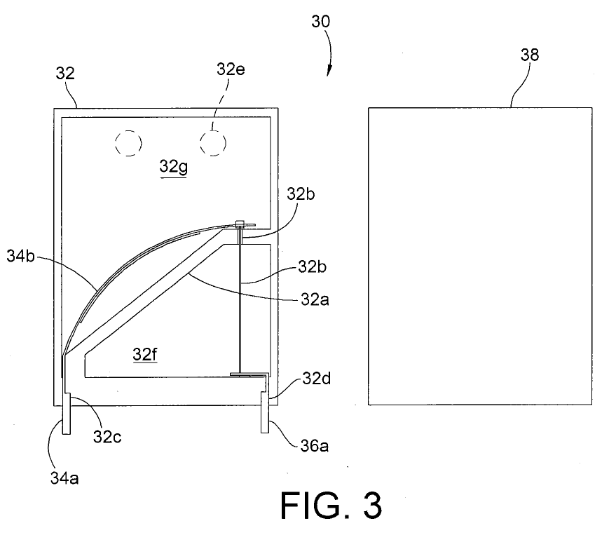

There are still other embodiments of the high voltage fuse. FIG. 3 depicts an embodiment of a high voltage fuse 30 in which housing 32 includes mounting tabs 32e on an underside of the housing. Housing 32 also includes an internal wall 32a for an arc barrier and an opening 32b for the fuse element. In this embodiment, housing 32 is divided into a first portion 32f and a second portion 32g. Connector 36a is mounted in an opening 32d of the housing and connector 34a is mounted in an opening 32c of the housing.

Connectors 34a, 36a may be male spade connectors suitable for mating with female spade connectors to a source of electrical power (36a) and to the appliance (34a). The connectors may be connected to the leaf spring 34b and fuse element 36b before assembly into the housing, and as discussed above, may even be assembled to each other. The leaf spring is connected to the fuse element by soldering or welding in the area of second portion 32g. A connector could be used instead or with a solder or weld joint. Terminal 34a may be crimped to leaf spring 34b or may be soldered, welded, or braze. Fuse element 36b may be crimped to terminal 36a, or may also be soldered, welded, or brazed to the terminal.

Together or separately, these parts may then be insert molded into housing 32 via an injection molding process, compression molding process, or other process for making thermoplastic or thermoset parts. This embodiment also demonstrates, by comparison with FIG. 2, the ease of determining the separation distance of portions of the fuse element when the fuse is activated. Housing 32 is elongated, as is the leaf spring 34b.

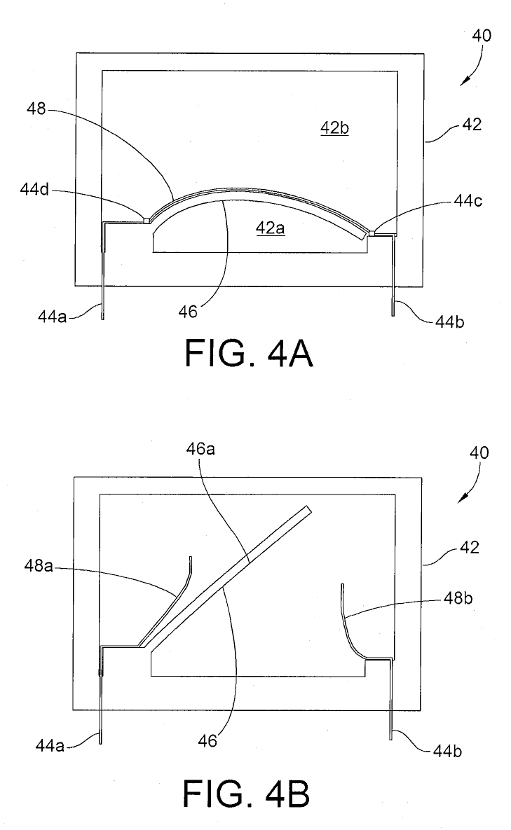

Yet another embodiment does not use a conductive leaf spring, but rather a non-conductive leaf spring. High voltage fuse 40, depicted in FIG. 4A, includes a four-sided housing 42, a cover (not shown), and a leaf spring 46 that is molded as part of the internal structure. Any suitable plastic may be used, but polypropylene, often used for “living hinges,” may be especially suitable because of its ability to flex and bend. Other possibilities include stiffer grades of polyethylene, ABS, nylon, and suitable engineering polymers. Leaf spring 46, which is not conductive, divides the interior of the housing into a first portion 42a and a second portion 42b both as-furnished and when the fuse is activated. The spring helps to separate the ends of the fuse a known particular distance when the fuse is activated.

Terminals 44a and 44b may be insert molded into the housing or may be assembled through suitable openings in the side of the housing. The terminals are both connected to fuse wire 48, the connections made by discrete connectors 44c, 44d as shown, or by soldering or welding fuse element 48 to the terminals, or by a combination of these techniques. Because of the need to place leaf spring 46 in flexure, as shown, it will be difficult to insert mold both terminals 44a, 44b and the fuse wire 48 into housing 42.

When the fuse is activated, the situation will be as depicted in FIG. 4B. The end of the leaf spring 46 was previously placed near terminal 44b, so that when fuse element 48 melts, first portion 48a will be longer than second portion 48b. In addition, leaf spring 46 will urge first portion 48a away from second portion 48b and also away from terminal 44b. Thus, fuse ends 48a, 48b will be well separated and the leaf spring itself will act as an arc barrier for the fuse. As is clear from FIGS. 4A and 4B, the spring separates the interior of housing 42 into two separated parts both before and after activation of the fuse element.

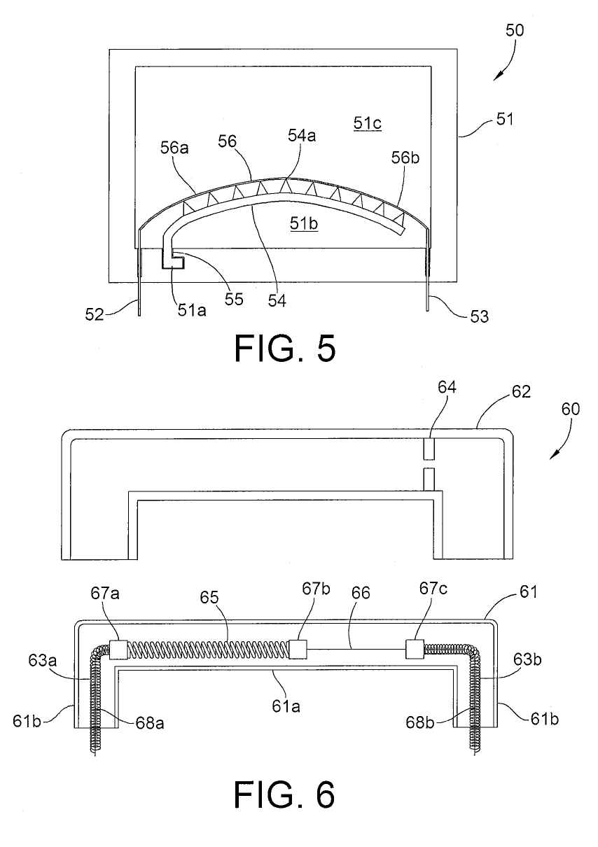

Other embodiments of the high voltage fuse are also possible. For instance, FIG. 5 depicts another embodiment, similar to that of FIG. 4, but in which the leaf spring is not formed integrally with the housing. Fuse 50 includes a housing 51 with a channel or notch 51 for receiving a separate leaf spring 54, which is preferably non-conductive, but which could also be conductive. The fuse includes first and second terminals 52, 53 and fuse element 56. Fuse 50 works in a manner similar to the other embodiments described above. When an overcurrent situation occurs, fuse element 56 melts and is partially pulled apart by the force of spring 54. When the fuse is activated and melts, distal fuse portion 56a remains in the left-hand portion 51a of the housing, near first terminal 52. Proximal fuse portion 56b moves to the upper portion of the housing 51c. Leaf spring 54 separates the two portions of the housing and also separates the distal and proximal ends of the fuse element. This embodiment has the ability to design the leaf spring to a desired material and thickness, in order to help tailor the force of the spring.

Some embodiments of spring surface are textured and additional embodiments include stand-off features to reduce thermal coupling with the fuse element to assure that the fuse elements melts on only a current overload. Examples are shown in FIG. 4B, in which spring 46 includes a textured surface 46a. The textured surface preferably results from a matching texture in the tool from which plastic spring 46 is molded. The texture may be one of many different patterns and preferably has a surface roughness from about 0.0005 to about 0.005 inches. FIG. 5 depicts spring 54 with short teeth 54a. The short teeth, from about 0.001 to about 0.010 inches tall, may be in the form of sawteeth or truncated sawteeth. Other embodiments may simply be in form of the teeth on an ordinary comb. All these help to reduce heat transfer between the spring and the fuse element.

Yet another embodiment may use a coil spring in tension with the fuse element, as shown in FIG. 6. Fuse 60 uses a U-shaped or C-shaped housing 61 and cover 62, the cover including stops or wire retainers 64 to react the spring 65 that holds fuse element 66 in tension. Housing 61 is divided into three portions, a middle portion 61a for holding the spring 65, fuse element 66, and connectors 67a, 67b and 67c. Connectors 67a, 67b connect the spring 65 to lead wire 63a and fuse element 66, while connector 67c connects fuse element 66 to lead wire 63b. Wires 63a, 63b are preferably equipped with insulation coverings 68a, 68b. Connectors 67a, 67c are preferably spade terminals.

When the fuse is assembled, housing 61 is divided into three parts, housing 61a holding the wire connectors or terminals 67a, 67c, coil spring 65, fuse element 66, and connector 67b, which connects the coil spring and fuse element. Cover 62 includes stops 64 which are preferably molded into the cover and separated a distance sufficient to allow passage of fuse element 66 but not coil spring 65 or connector 67b. When assembled, stops 64 react spring 66, which is held in tension by stops 64 on the left side of housing area 61a, and friction between the housing and the wire 61b and insulation 63b on the right side of the housing. Note also that stops 64 on cover 62 will be on the left side when the cover is assembled to housing 61. When the fuse element self-heats and melts, the tension in the spring and in the fuse element will cause the ends of the fuse element to separate and the circuit will be opened.

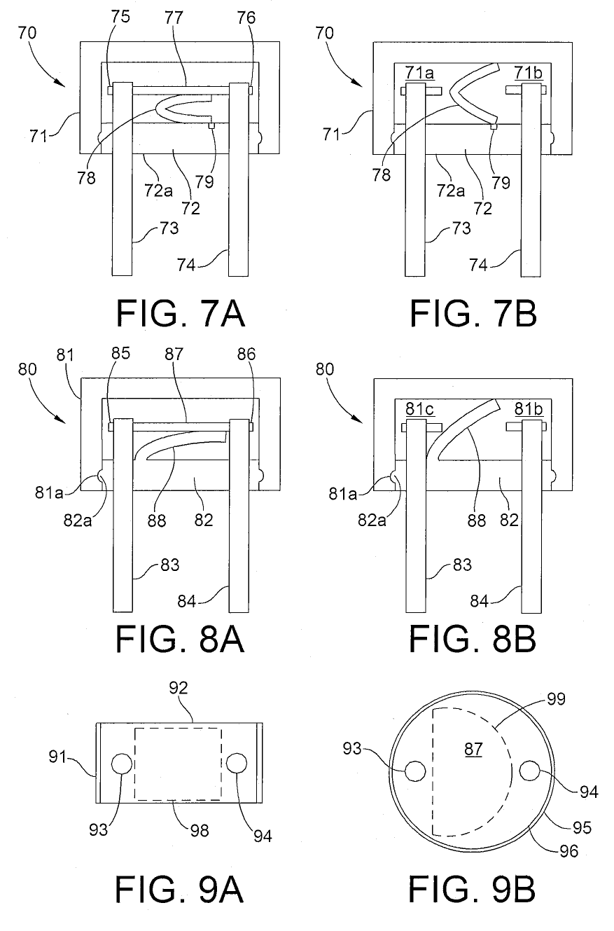

There are still additional embodiments of the high voltage fuse of the present invention. FIGS. 7a-7b depict an embodiment in which a free-floating spring urges apart the fuse element during an overcurrent condition. Fuse 70 includes a plastic housing 71 and a plastic housing closure 72 which is assembled to the plastic 71 housing as shown. Terminals 73, 74 are molded into housing closure 72 and fuse element 77 is connected across the terminals with connectors 75, 76.

Upon assembly, free-floating leaf spring 78 is wedged between closure element (housing side or end) 72 and the fuse element and is retained by optional notch 79. Closure element 72 is held in housing 71 by a cylindrical snap fit as shown. Upon an overcurrent or overvoltage condition, fuse element 77 self-heats, and is urged apart by spring 78. Spring 78 expands as shown in FIG. 7b, acting as an arc barrier and dividing housing 71 into two parts, left portion 71a and right portion 71b. The separation and the arc barrier prevent further arcing between the separated ends of the fuse element. As shown in FIG. 7c, the overall shape of fuse 70 is a rectangular box, with cylindrical terminals 73, 74. Leaf spring 78 is actually in the shape of a rectangle, and is bent in half upon assembly into fuse 70.

Yet another embodiment is depicted in FIGS. 8a-b. Fuse 80 includes a housing 81 and a closure side 82. Terminals 83, 84 are molded into closure side 82 and fuse element 87 is connected across the terminals, preferably with connectors 85, 86. In some embodiments, the terminals 83, 84 may themselves also be connectors. Leaf spring 87 may also be molded in place as part of closure 82, to provide flex stress across fuse element 87. Terminals 83, 84 are molded into closure 82 and the fuse element 87 is connected across the terminals, optionally with connectors 85, 86 if they are needed. The assembly is cylindrical snap-fit into housing 81 with snap fit portions 81a, 82a, i.e., groove 81a and tongue 82a. Rather than being molded as part of closure 82, leaf spring 87 may instead be a separate part in the shape of a thin cylinder of circular cross section, bent in half to place fuse element 87 in flexure. Upon an overcurrent or overvoltage condition, fuse element 87 self-heats, and is urged apart by spring 88. Spring 88 expands as shown in FIG. 8b, acting as an arc barrier and dividing housing 81 into two parts, left portion 81c and right portion 81b. The separation and the arc barrier prevent further arcing between the separated ends of the fuse element.

The embodiments of FIGS. 7a-7b and 8a-8b may be in a small boxy, breadbox shape, as shown in FIG. 9a, or may be in the shape of a cylinder or hockey puck, as shown in FIG. 9b. FIGS. 9a and 9b are alternate bottom views. In FIG. 9a, the housing 91 is a box, with a “lid” type of closure, into which terminals 93, 94 are mounted. Spring 98 is in the form of a bent rectangle, and is bent and placed as shown by spring 78 in FIG. 7a upon assembly. FIG. 9b depicts a cylindrical or hockey-puck configuration, in which terminals 93, 94 are molded into closure 96 for hollow cylindrical housing 95. Spring 99 may be have a circular cross section and is bent in half for insertion, or may have a semi-circular cross section and is molded in place as is the spring in FIGS. 8a-8b.

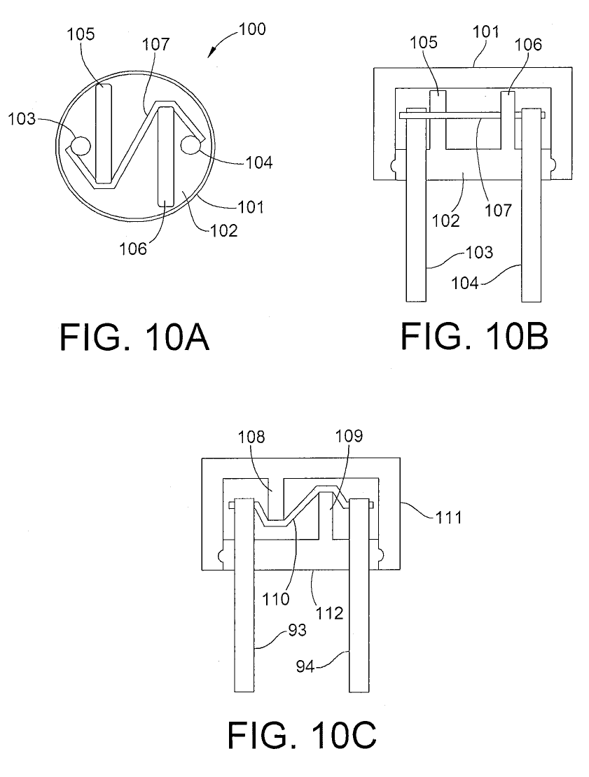

Additional embodiments are shown in FIGS. 10a-10c. In FIGS. 10a-10b, fuse 100 is also in the general shape of a cylinder, with an outer hollow cylindrical housing 101, open on one end, and a closure 102, which snap fits into housing 101. Terminals 103, 104 are molded into closure 102 and fuse element 107 is connected across terminals 93, 94, with arc barriers 105, 106 molded into the closure. As seen in FIG. 10a, fuse element 107 has a serpentine shape as it traverses around the arc barriers, behind one and in front of another in a plane. In a different embodiment, as shown in FIG. 10c, one each of the arc barriers 108, 109 may be molded into a housing 111 and a closure 112. Fuse element 110, spanning terminals 93, 94, now has a serpentine shape in a different plane, traversing under arc barrier 108 and over arc barrier 109. While FIGS. 10a-10c depict a cylindrical shape, fuses with this configuration may have a housing with a different shape, such as a boxy housing or a generally polygonal housing.

Fillers

As noted above, the purpose of the high voltage fuses described herein is to prevent or minimize arcing. One way in which that may be accomplished is to fill the inside of the fuse with a filler that minimizing the chances or arcing, an arc-quenching material. The material is preferably an inorganic, dry, granular, nonconductive material. Examples include quartz sand, silica, ceramic powders, and calcium sulfate. This material is preferably placed into the housing before the housing is closed. Normally, arc-quenching material will greatly assist in minimizing after melting of the fuse element.

Closure

Many of the fuses discussed herein are fabricated in two parts, such as a housing and a cover. After the terminals and the fuse element are connected, it is necessary to close the fuse. The two parts of the housing and cover, or housing and drawer in other embodiments, may be closed in many ways. One preferred way, when using plastic parts, is to simply place a cover over a housing, place an ultrasonic horn over the cover, and seal the two together by ultrasonic welding. A more costly way is to plastic-weld the parts together, such as by running a bead of polypropylene “welding” bead around the split line between the parts. The parts may also use an adhesive for joining, or they may use the technique of solvent bonding, in which a solvent that melts both parts is placed on one side or the other or both, and the parts are pressed together. As shown in some of the embodiments above, the parts may be equipped with features for a friction fit, such as matching tongue-and groove features or snap fit features, such as male and female snap-fit portions. Any suitable means for closing and securing may be used.

It should be understood that various changes and modifications to the presently preferred embodiments described herein will be apparent to those skilled in the art. Such changes and modifications can be made without departing from the spirit and scope of the present subject matter and without diminishing its advantages. It is intended that such changes and modifications be covered by the appended claims.

What is claimed is:

1. A fuse, comprising:
a housing having a first part and a second part;
a first terminal mounted near the first part and a second terminal mounted near the second part;
a fuse element mounted in the first part of the housing and connected to the first terminal;
a conductive spring mounted in the second part of the housing, the spring connected to the second terminal and connected to the fuse near the first part, wherein the fuse element and spring are configured to place the fuse element in a state of flexure, and are also configured so that when the fuse element opens, the spring pulls away from the first part; and
a cover configured for covering the first part and the second part.

2. The fuse according to claim 1, wherein the spring is a leaf spring.

3. The fuse according to claim 1, wherein the first part and the second part are separated by an arc barrier.

4. The fuse according to claim 1, wherein the first and second terminals are mounted on one end of the housing.

5. The fuse according to claim 1 further comprising an arc-quenching filler inside the housing.

6. The fuse according to claim 1, wherein the fuse element and the spring are configured so that after the fuse opens, there is a minimum separation between separated portions of the fuse element.

7. The fuse according to claim 1, wherein the cover and the housing are assembled by a process selected from the group consisting of welding, adhering, or by friction fitting together.

8. The fuse according to claim 1, wherein the housing further comprises mounting tabs or orifices for mounting tabs.

9. A fuse, comprising:
a housing having a first part and a second part separate from the first part;
a first terminal mounted near the first part and a second terminal mounted near the second part;
a fuse element mounted in the first part of the housing and connected to the first terminal;
a conductive spring mounted in the second part of the housing, the spring connected to the second terminal and connected to the fuse near the first part, wherein the fuse element and spring are configured to place the fuse element in a state of flexure, and are also configured so that when the fuse element opens, the spring pulls away from the first part; and
a cover configured for covering the first part and the second part.

10. The fuse according to claim 9, wherein the spring comprises a texture or a feature to reduce heat transfer between the spring and the fuse element.

11. The fuse according to claim 9, wherein the first and second terminal are mounted in parallel on a single side of the housing.

12. The fuse according to claim 9, wherein the fuse element and the spring are configured so that after the fuse opens, there is a minimum separation of 17.5 mm between separated portions of the fuse element.

13. The fuse according to claim 9, further comprising an arc-quenching filler.

14. The fuse according to claim 9, wherein the fuse element is mounted between the first terminal and an arc barrier separating the first and second parts.

15. The fuse according to claim 9, wherein a majority portion of the fuse element is mounted in the first part.

16. A fuse, comprising:
a housing;
a first terminal and a second terminal mounted to the housing;
a fuse element mounted in the housing and connected to the first terminal and the second terminal;
a non-conductive spring mounted in the housing between the first and second terminals, wherein the spring is configured to place the fuse element in a state of flexure, and is also configured so that the spring urges apart the fuse element upon melting of the fuse element; and
a cover configured for covering the first part and the second part.

17. The fuse according to claim 16, wherein the spring is formed as part of the housing.

18. The fuse according to claim 16, wherein the housing and spring are configured so that ends of the fuse element separate a minimum distance when the fuse is activated.

19. The fuse according to claim 16, wherein the spring comprises a texture or a standoff to reduce heat transfer between the spring and the fuse element.

20. The fuse according to claim 16, wherein the housing and spring are configured so that after melting of the fuse element, the non-conductive spring is between separated ends of the melted fuse, acting as an arc barrier.

21. The fuse according to claim 16, wherein the cover and the housing are assembled by a process selected from the group consisting of welding, adhering, or by friction fitting together.

22. The fuse according to claim 16, wherein the first and second terminals are mounted to the housing by insert molding.

23. The fuse according to claim 16, further comprising an arc-quenching filler.

24. A fuse, comprising:
a housing;
a spring and a fuse element in series with the spring;
a first terminal and a second terminal connected with the spring and the fuse element, the first and second terminals mounted in the housing; and
a cover with a stop, the cover and the housing configured so that when the cover is assembled to the housing, the fuse element passes through a pathway in the stop, and wherein the spring and the fuse element are held in tension by the stop and at least one of the first and second terminals.

25. The fuse of claim 24, wherein the housing and the cover are molded plastic parts, and wherein at least one of the stop, the first terminal and the second terminal are molded into the housing or the cover.

26. A fuse, comprising:
a housing;
a closure for the housing;
two terminals assembled into the closure;
two arc barriers within the housing, the arc barriers configured to resist arcing upon activation of the fuse; and
a fuse element connected between the terminals and traversing a serpentine path between the terminals.

27. The fuse of claim 26, wherein one arc barrier is mounted on the housing and the other arc barrier is mounted on the closure.

28. The fuse of claim 26, wherein the arc barriers on mounted on one of the housing and the closure.

29. A method of protecting an electrical device with a fuse, the method comprising:
connecting the electrical device to a source of electrical power in series with a fuse, wherein the fuse comprises a housing having a first part and a second part, a first terminal mounted near the first part and a second terminal mounted near the second part, a fuse element connected to the first terminal and the second terminal, and a spring mounted in the housing, wherein the fuse element and spring are configured so that the spring places the fuse element in flexure;
opening the fuse by separating the fuse element with the spring when the fuse element melts; and
separating the ends of the fuse element a particular minimum distance.

30. The method of claim 29, further comprising preventing an arc by providing a non-conductive arc barrier or arc-quenching material between the ends of the fuse element.

31. The method of claim 29, wherein the fuse comprises an arc barrier separating the first terminal and the second terminal.

32. The method of claim 29, wherein the step of connecting is accomplished by connecting the electrical device and the source of electrical power directly to the first and second terminals without a fuse holder.

33. The method of claim 29, wherein at least one of the spring and second terminal are molded into the housing.
